(19) United States
(12) Patent Application Publication
(10) Pub. No.: US 2003/0207632 A1
(43) Pub. Date: Nov. 6, 2003

(54) Disposable washcloth article and a method of making and using the washcloth

(76) Inventor: JoAnn Adele Brooks, Arlington, TX (US)

Correspondence Address: KIMBERLY-CLARK WORLDWIDE, INC., 401 NORTH LAKE STREET, NEENAH, WI, 54956

(21) Appl. No.: 10/138,352

(22) Filed: May 3, 2002

(51) Int. Cl. B32B 27/12; B32B 27/04

(52) U.S. Cl. 442/164; 442/59; 442/327; 442/417; 442/71

(57) ABSTRACT

This invention relates to a disposable washcloth and a method of making and using the washcloth. The disposable washcloth includes an aqueous solution incorporated onto a nonwoven basesheet. The aqueous solution includes a combination of a moisturizer, a humectant, an alpha hydroxy acid compound, a skin vitamin, a mild surfactant and a preservative. A method of making and using the disposable washcloth includes providing a continuous web of nonwoven basesheet material onto which the aqueous solution is incorporated. The continuous web is longitudinally folded and transversely cut to provide a plurality of individual washcloths. A select number of the individual washcloths are stacked in a clip and placed in a package. The package of washcloths is heated to a select temperature above 98° F. One or more of the individual disposable washcloths are removed from the package to provide a warm, quick drying, moisturizing bath to a human being.

### BACKGROUND OF THE INVENTION

Disposable articles of the type generally known as disposable washcloths, wet wipes or cleansing wipes for use in a variety of personal hygiene care applications are well known in the art. A variety of such products that utilize a basesheet impregnated with a solution adapted to cleanse, moisturize and/or revitalize the skin are commercially available. Such products, also known as bathing or bath kits, often contain multiple sheets impregnated with an aqueous solution or oil-in-water emulsion. These disposable bath kits offer caregivers the advantages of bedside bathing without the mess of a soap and water basin approach. Because of the efficiency and ease of use, these products have been adopted for use in hospitals and long-term care facilities to provide a less messy and a less time consuming means for bathing a bed-bound patient. In recent years, the number of elderly adults who remain in their homes or living with an adult caretaker has increased. As a result, home health care providers are beginning to adopt disposable washcloths as a means to ease the time and logistical burdens of caring for an elderly person who may not be able to use the typical home bathroom facilities to bathe.

One complication of aging, poor health, and nutrition is reduced skin hydration resulting in dry, devitalized skin that is prone chapping, redness and/or irritation. Vitamins and minerals lost from the skin as part of the aging process or illness contribute to skin devitalization. Bathing can further dehydrate the skin resulting in severely dry skin with cracking and/or fissuring. In addition, the mechanical abrasion of washing fragile skin also causes tiny tears in the skin, which may lead to infection.

Some disposable bath kits contain above average amounts of humectants. The use of humectants, such as glycerin, in the solutions of bathing kits can reduce the appearance of dry skin and boost skin hydration levels. However, such materials often leave a sticky or tacky residue on the skin surface after bathing. Additionally, most disposable bath kits employ surfactants to assist in the cleansing process. However, surfactants can deplete lipid levels in the skin further contributing the devitalization of the skin. Finally, the basesheet material used in disposable bath kits can contribute to dehydration of the skin by abrading the surface leaving abrasions and/or irritated areas that are prone to transepidermal water loss.

### SUMMARY OF INVENTION

Now, a disposable washcloth article has been developed that may provide moisturization and revitalization to mature, devitalized skin without leaving a sticky residue. By selecting a basesheet that is gentle and non-abrasive to the skin, the disposable washcloth article can be used to cleanse the skin without increasing or causing redness or irritation. By including a combination of moisturizers, humectants, alpha hydroxy acids and skin vitamins in the aqueous solution, the disposable article can be used to cleanse the skin and deposit compounds that promote skin health and prevent dehydration of the epidermis. By carefully selecting the combination of ingredients the disposable wash cloth article has the ability to retain a consumer acceptable scent, glide and after-feel following conventional or microwave heating. The use of a low-foaming, mild anionic or amphoteric surfactant eliminates the need to dry the skin after cleansing thereby reducing irritation from additional mechanical wiping and allowing the selected compounds to remain on the epidermis to moisturize and revitalize the skin. Additional compounds such as anti-inflammatory agents, emollients, natural botanicals and fragrances can optionally be added to the aqueous solution to further enhance the feel, efficacy, moisturizing and revitalizing characteristics of the disposable article. Furthermore, the disposable washcloth article may be heated to a temperature approximately equal to or above the normal body temperature of about 98° F. (about 37° C.) thereby allowing the aqueous solution to dry on the skin more quickly and providing a more comfortable and soothing experience for the care recipient.

Briefly, this invention relates to a disposable article for use as a washcloth. The disposable article includes an aqueous solution applied to a basesheet. The aqueous solution includes a combination of a moisturizer, a humectant, an alpha hydroxy acid compound, a skin vitamin, a mild anionic or amphoteric surfactant and a preservative.

The disposable article is capable of providing moisturization and revitalization of the user's skin.

In another embodiment, the disposable article includes an aqueous solution applied to a nonwoven basesheet. The aqueous solution includes a combination of potassium lactate, a moisture retaining humectant, an alpha hydroxy acid compound, a skin vitamin, a mild anionic surfactant, a preservative, and an anti-inflammatory agent.

In a further embodiment, the disposable article includes an aqueous solution applied to a nonwoven basesheet. The aqueous solution includes potassium lactate, sodium polyaspartate, lactic acid, panthenol, disodium cocopolyglucose sulfosuccinate, a preservative, zinc lactate, and PEG-7 glyceryl cocoate.

A method of making the present invention includes providing a continuous web of nonwoven basesheet material. An aqueous solution including a combination of a moisturizer, a humectant, an alpha hydroxy acid compound, a skin vitamin, a mild anionic or amphoteric surfactant, and preservative is incorporated unto the continuous web. The continuous web having the aqueous solution incorporated thereon is longitudinally folded and is then transversely cut at select intervals to provide a plurality of individual basesheets. A select number of individual basesheets are stacked to form a clip and the clip is placed in a package.

An alternative method of making the present invention includes providing a continuous web of nonwoven basesheet material. An aqueous solution including a combination of a moisturizer, a humectant, an alpha hydroxy acid compound, a skin vitamin, a mild anionic surfactant, and a preservative is incorporated onto the continuous web. The continuous web of nonwoven basesheet material having the aqueous solution incorporated thereon is transversely perforated at select intervals to provide a plurality of detachable individual basesheets. The perforated continuous web is wound into a roll and is then transversely cut along a single perforation such that the roll contains a select number of detachable individual basesheets. The roll is placed in a package. Additionally, the perforated web may be longitudinally folded prior to winding to reduce the width dimension of the detachable individual basesheets.

One method of using the present invention includes providing a package containing a plurality of individual basesheets having an aqueous solution incorporated thereon. The aqueous solution includes a combination of a moisturizer, a humectant, an alpha hydroxy acid compound, a skin vitamin, a mild anionic or amphoteric surfactant, and a preservative. The package is heated to a select temperature above 98° F. (about 37° C.) and one or more individual basesheets are removed from the package to provide a warm, quick drying bath to a human being.

Another method of using the present invention includes providing a package containing a plurality of individual basesheets having an aqueous solution incorporated thereon. The aqueous solution includes a combination of a moisturizer, a humectant, an alpha hydroxy acid compound, a skin vitamin, a mild anionic or amphoteric surfactant, and a preservative. The package is heated in a microwave oven for a select time and on or more individual basesheets are removed from the package to provide a warm, quick drying bath to a human being. Desirably, the individual basesheets are removed sequentially and the package is resealed after each individual basesheet is removed in order to retain the heat within the package of a longer period of time.

### DETAILED DESCRIPTION

The disposable article of the present invention includes a basesheet and an aqueous solution incorporated unto the basesheet. Suitably, the disposable article is capable of providing moisturization and revitalization of a user's skin. As used herein, the term “devitalized” is used to describe skin that is chapped, cracked and/or dehydrated. The term “moisturization and revitalization” means that the disposable article is capable of delivering a sufficient level of effective compounds such that moisturization levels are retained in the skin for up to 6 hours after cleansing. The term “effective compounds” designates those compounds that promote hydration, moisturization, and relipidization of mature skin. Effective compounds include, but are not limited to, moisturizers, humectants, emollients and/or re-fatting agents, and skin vitamins.

Advantageously, the basesheet is water insoluble and low Tinting so as not to catch on calloused or dry skin. The basesheet should be resistant to degradation by the chemicals, particularly the surfactants, in the aqueous solution and resistant to thermodegradation resulting from at least two heatings up to a temperature of at least about 250° F. (about 120° C.). As used herein, the terms “resistant to thermodegradation” and “thermostable” are used to defined materials that do not produce undesirable chemical breakdown products upon repeated heating to a select temperature. The basesheet should have adequate tensile strength for durability during the washing of the body and should be non-abrasive. Additional characteristics of the basesheet include adequate loft and porosity to provide sufficient fluid retention properties so that the incorporated aqueous solution remains essentially in the basesheet and does not significantly pool or puddle at the bottom of the package containing the disposable article.

The basesheet should also have a sufficient thickness to provide a plush feel on the skin and should be dimensioned to provide an adequate cleaning surface. The basesheet may be dimensioned to have a square or rectangular shape. Alternatively, the basesheet may be dimensioned to have an irregular shape to accommodate packaging and dispensing needs. Desirably, the basesheet of the disposable article has a width dimension of at least about 12 inches (about 30.5 cm) and a length dimension of at least about 12 inches (about 30.5 cm). More desirably, the basesheet should have a width dimension of at least about 9 inches (about 22.9 cm) and a length dimension of at least about 9 inches (about 22.9 cm). And most desirably, the basesheet should have a width dimension of at least about 8 inches (about 20.3 cm) and a length dimension of at least about 8 inches (about 20.3 cm). The basesheet may be made from any suitable synthetic or natural material or blend thereof that is durable, non-abrasive, fluid retentive and disposable. Examples of appropriate synthetic materials include nonwoven materials such as hydroentangled, needlepunched, meltblown, coform, themobonded, spunbond, airlaid, water laid, or carded materials comprising a polymer fibers. Suitable polymer fibers include polyolefins such as polyethylene and polypropylene, rayons, polyesters, dacron, nylon, fortrel, kodel, viscose, viscose-lyocell and mixtures thereof. Examples of suitable natural materials include woven and nonwoven materials made of natural fibers such as cotton, wood pulp or mixtures thereof. One example of a blended material suitable for use as a basesheet is a coform material made of a blend of wood pulp fibers and polypropylene fibers. Desirably, the synthetic fibers have not been treated or processed with sulfur containing compounds. Suitably, the fibers used in manufacturing the basesheet material should contain less than about 35 parts per million sulfur (expressed as ppm carbon disulfide). Furthermore, the fibers used in manufacturing the basesheet should contain less than about 25 ppm formaldehyde. It has been noted that reducing or eliminating the presence of sulfur containing compounds and formaldehyde in the basesheet material aids in preventing malodor upon heating of the basesheet material. Additionally, reducing or eliminating the presence of these compounds is desirable for creating a low irritation potential for fragile, mature skin.

Desirably, the basesheet is a nonwoven material. More desirably, the basesheet is a nonwoven material made up of a blend of two or more synthetic fibers. Most desirably, the basesheet is a nonwoven material made up of either a blend of rayon and polyester fibers or a blend of viscose-lyocell and polyester. The basesheet material may include from about 25% to about 75% polyester fibers. Suitably, the basesheet material is made up of about 30% polyester fibers. More suitably, the basesheet material is made up of about 50% polyester fibers. The basesheet material may include from about 25% to about 75% rayon or viscose-lyocell fibers. More specifically, the basesheet material includes about 50% rayon or viscose-lyocell fibers. Most specifically, the basesheet material is a nonwoven material made up of a blend of about 50% polyester fibers and about 50% viscose-lyocell fibers.

Suitably, the basesheet material has a basis weight of from about 1 ounce per square yard (about 34 grams per square yard) to about 6 ounces per square yard (about 205 grams per square yard). More suitably, the basesheet material has a basis weight of about 2 ounces per square yard (about 68 grams per square meter) to about 5 ounces per square yard (about 170 grams per square meter). Most suitably, the basesheet material has a basis weight of about 4 ounces per square yard (about 135 grams per square meter).

Advantageously, the basesheet should retain a sufficient quantity of the incorporated aqueous solution to form and maintain a moist disposable article. As used herein, the term “moist” means that the basesheet retains a sufficient amount of the aqueous solution to make the basesheet slightly to moderately wet. For example, the disposable article should feel damp to the skin but an excess of the incorporated aqueous solution does not drip or run-off the basesheet creating a mess.

The amount of aqueous solution incorporated on each individual basesheet may vary depending upon the type of basesheet material used, the type of package used to contain the washcloth, and the desired end-use of the washcloth. Generally, each individual basesheet can contain from about 100 to about 600 weight percent based on the dry weight of the individual basesheet. Desirably, each individual basesheet can contain from about 200 to about 450 weight percent aqueous solution based on the dry weight of the individual basesheet. Advantageously, the individual basesheet contains about 260 weight percent aqueous solution based on the dry weight of the individual basesheet. Thus, when individual sheets are removed from their packaging they are moist and ready to use.

The aqueous solution includes a combination of a moisturizer, a humectant, an alpha hydroxy acid compound, a skin vitamin, a mild surfactant and a preservative. Advantageously, the aqueous solution contains from about 0.5% to about 1.0% moisturizer, from about 0.8% to about 3.0% humectant, from about 0.03% to about 0.05% alpha hydroxy acid compound, from about 0.025% to about 2.0% skin vitamin, from about 0.3% to about 0.5% mild surfactant and from about 0.2% to about 0.6% preservative. As used herein, the term “mild surfactant” is defined to mean that the surfactant should be gentle, causing little or no irritation to and/or dehydration of the skin. Optional compounds such as anti-inflammatory agents, emollients, anti-microbial agents, natural botanicals and fragrances may be includes in the aqueous solution in concentrations ranging from about 0.01% to about 1%.

Suitably, the individual compounds included in the aqueous solution should be natural active ingredients or derivatives thereof. As used herein, the term “natural active ingredients” is defined to mean materials derived from natural plant or animal sources. Advantageously, each individual compound in the aqueous solution should assist to revitalize, hydrate or relipidize the skin. More advantageously, the individual compounds in the aqueous solution should complement each other in order to provide a pH balanced, low foaming solution that dries quickly and does not leave a sticky or tacky residue on the skin. Desirably, the aqueous solution is pH balanced in order to avoid affecting the natural pH balance of the skin and/or exacerbating dry, devitalized skin. The pH of the aqueous solution can be about 4.0 to about 7.0 and more specifically from about 4.5 to about 5.5.

Advantageously, the individual compounds in the aqueous solution should be selected such that moisturization levels are retained in the skin for up to about 2 hours. More advantageously, the individual compounds in the aqueous solution should be selected such that moisturization levels are maintained in the skin for up to about 4 hours. Most advantageously, the individual compounds in the aqueous solution should be selected such that moisturization levels are retained in the skin for up to 6 hours after cleansing.

Each individual compound should be resistant to chemical degradation when exposed to heat. Desirably, the individual compounds should be chemically stable to multiple heatings. More desirably, the individual compounds should also be chemically stable to multiple heatings in combination with the other compounds of the aqueous solution and basesheet. Thus, the individual compounds included in the aqueous solution should be selected such that they are compatible with each other in solution and compatible with the basesheet material such that the disposable wash cloth article remains chemically stable following conventional or microwave heating and a sufficient level of effective compounds are delivered to the skin to provide moisturization and revitalization.

Advantageously, the aqueous solution includes the combination of a moisturizer, a humectant, an alpha hydroxy acid compound, a skin vitamin, a mild surfactant, and a preservative.

The aqueous solution includes at least one moisturizer. Desirably, the aqueous solution should include from about 0.1% to about 1.0% moisturizer. Suitable moisturizers for use in the present invention include alkali metal salts of lactic acid such as potassium lactate or sodium lactate. One suitable moisturizer in the form of potassium lactate is available under the registered trademark PURASAL from Purac America, 111 Barclay Boulevard, Lincolnshire Corporate Center, Lincolnshire, Ill., 60069. Other suitable moisturizers include sodium polyaspartate, panthenol, glycerin, glycerin derivatives, hydrogenated starch hydrolysate, hydrolyzed proteins, sugars, aloe, propylene glycol, polyethylene glycols, urea, and pyrrolidone carboxylic acid and salts thereof. Other moisturizers known in the art can also be used in the present invention.

The aqueous solution also includes at least one humectant. The addition of a humectant helps maintain an effective level of moisture in the skin, which minimizes dehydration associated with mature skin. Desirably, the aqueous solution includes from about 0.8% to about 3.0% humectant. More desirably, the aqueous solution includes from about 1.5% to about 3.0% of a moisture retaining humectant. Suitable humectants for use in the present invention include anionic polymer humectants. One example of a suitable anionic polymer humectant is sodium polyaspartate available under the registered trademark AQUADEW SPA-30 from Ajinomoto U.S.A., Inc., Country Club Plaza, West 115 Century Road, Paramus, N.J. 07652. Other suitable humectants include propylene glycol, glycerin, muccopolysaccharides, sodium pyrrolidone carboxylic acid (sodium PCA), sorbitol, mannitol, dextrin, soluble collagen, maltodextrin, xylitol, sodium lactate, potassium lactate, maltitol, honey, glycereth-26, acetamide MEA, lactamide MEA, PEG-12, panthenol, and ethoxy-diglycol. Other suitable humectants known in the art can also be used.

The aqueous solution also includes an alpha hydroxy acid compound. The alpha hydroxy acid compound helps to buffer the pH of the aqueous solution and maintain the pH within a desired range. Alpha hydroxy acids are less dehydrating and/or irritating to mature, devitalized skin than the inorganic acids typically used in other water based bath kits. Alpha hydroxy acids are especially suitable for use in combination with sodium or potassium lactate. Generally, it is desirable to select an alpha hydroxy acid that is mild.

Advantageously, the aqueous solution contains from about 0.03% to about 0.05% alpha hydroxy acid compound. Alpha hydroxy acid compounds suitable for use in the present invention include citric acid, malic acid, glycolic acid and lactic acid. Desirably, the aqueous solution includes lactic acid. One example of a suitable lactic acid material is available under the registered trademark PURAC from Purac America, Inc., 111 Barclay Boulevard, Lincolnshire Corporate Center, Lincolnshire, Ill. 60069.

Desirably, the aqueous solution also includes at least one skin vitamin. Advantageously, the aqueous solution includes from about 0.025% to about 2.0% of a skin vitamin. More advantageously, the aqueous solution includes from about 0.1% to about 1.0% of a skin vitamin. Most advantageously, the aqueous solution includes from about 0.3% to about 0.5% of a skin vitamin. Suitable skin vitamins include Vitamin E (tocopheryl acetate), dexpanthenol (pro-vitamin B5) and magnesium ascorbyl phosphate. The addition of useful levels of skin vitamins help to soothe and replenish dry, devitalized skin. One skin vitamin suitable for use in the present invention is dexpanthenol available under the trade name D-PANTHENOL USP from BASF Corporation, having an office at 3000 Continental Drive North, Mount Olive, N.J. 07828.

The aqueous solution includes at least one mild surfactant. Desirably, the aqueous solution includes at least one mild anionic or amphoteric surfactant. The selected surfactant should generally be low foaming thereby preventing excessive foam formation during heating of the disposable washcloth. The use of a mild surfactant that is also low-foaming helps to minimize the possibility of leakage of the solution from the packaging during heating and provide a less messy, fast-drying bath for bed-bound patients. Excessive foam formation during heating can cause expansion of the package that results in the development of fluid leaks. Furthermore, excessive foam formation can make the individual washcloths slippery and difficult to handle. In addition, excessive foaming of the aqueous solution during heating can cause the individual washcloths to drip during use depositing the solution and/or foam on other surfaces and the bedding of a bed-bound patient. Also, foam takes longer to break down and dry than an unfoamed solution and may require additional drying of the skin by rubbing that can exacerbate dry devitalized skin. Finally, because foam also takes longer to break down and dry than unfoamed solution, the user may experience an uncomfortable cooling or chilling sensation. Desirably, the selected surfactant is a mild anionic surfactant or a mild amphoteric surfactant.

Specifically, the aqueous solution includes from about 0.3% to about 0.5% mild anionic or amphoteric surfactant. Mild anionic surfactants suitable for use in the present invention include arginine cocoate and esters of alkylpolyglucosides such as sodium cocopolyglucose tartrate and disodium cocopolyglucose citrate. Desirably, the aqueous solution includes a sulfosuccinate ester of an alkylpolyglucoside such as disodium cocopolyglucose sulfosuccinate. Arginine cocoate is available under the registered trademark AMINOSOAP AR-12 from Ajinomoto U.S.A., Inc., having an office at Country Club Plaza, West 115 Century Road, Paramus, N.J. 07652. The cocopolyglucose surfactants may be obtained under the product names EUCAROL AGE-ET, EUCAROL AGE-EC, and EUCAROL AGE-SS, respectively, from Pilot Chemical Company, having an office at 11756 Burke Street, Santa Fe Springs, Calif. 90670.

Desirably, the aqueous solution includes at least one preservative. Suitably, the preservative should be effective against yeast, particularly Candida albicans, molds such as A. niger and T. luteus, fungi and bacteria, particularly S. aureus, E. coli, E. cloacae, P. aeruginosa, and B. cepacia. Advantageously, the preservative of this formulation is efficacious to preserve the product after conventional or microwave heating. More advantageously, the preservative maintains its efficacy after repeated exposure to heating and cooling. The preservative should be present in an amount in the aqueous solution sufficient to prevent the growth of yeast, mold, fungi, and bacteria. Specifically, the aqueous solution should include from about 0.2% to about 0.6% preservative.

One preservative suitable for use in the present invention is diazolidinyl urea. This preservative is available under the registered trademark GERMALL II from ISP Sutton Laboratories, having an office at 116 Summit Avenue, P.O. Box 837, Chatham, N.J. 07928. Other preservatives known in the art, such as 1,3-di-(hydroxymethyl)-5,5-dimethylhydantoin (also known DMDM hydantoin), 3-iodo-2-propynyl butyl carbamate (also known as IPBC), methyl paraben, disodium ethylenediamine tetraacetic acid (also known as disodium EDTA), phenoxyethanol, or combinations thereof, may also be used, in place of or in combination with diazolidinyl urea, in the present invention so long as they are gentle and do not contribute to the dehydration or irritation of the skin.

The aqueous solution can optionally include additional compounds to enhance the feel, efficacy, moisturizing and revitalizing characteristics of the disposable article. Additional compounds suitable for use with the combination of a moisturizer, a humectant, an alpha hydroxy acid compound, a skin vitamin, a mild surfactant and a preservative include anti-inflammatory agents, emollients, anti-microbial agents, natural botanicals and fragrances.

For example the aqueous solution may include an anti-inflammatory agent. The anti-inflammatory agent is used to reduce the appearance of redness and swelling of the epidermis due to dehydration and/or mechanical abrasion of devitalized skin. Desirably, the aqueous solution includes from about 0.1% to about 0.6% anti-inflammatory agent.

One anti-inflammatory agent suitable for use in the present invention is zinc lactate available under the registered trademark PURAMEX from Purac America, Inc., 111 Barclay Boulevard, Lincolnshire Corporate Center, Lincolnshire, Ill. 60069. Other anti-inflammatory agents known in the art, such as allantoin and 18-beta-glycerrhetinic acid, may also be used.

The aqueous solution may also include PEG-7 glyceryl cocoate. This polyethylene glycol ether derivative serves to enhance the mildness of the aqueous solution by modify the action of the surfactant making it more skin-friendly and less dehydrating and/or irritating. For example, the aqueous solution may include from about 0.2% to about 0.3% of PEG-7 glyceryl cocoate available under the product name GLYCEROX HE from Croda Inc., having an office at 7 Century Drive, Parsippany, N.J. 07054.

Natural botanicals may also be included in the aqueous solution to assist in moisturizing the skin and/or soothing dry, irritated mature skin. Some suitable natural botanicals for use in the present invention include aloe vera, chamomile, oat extract, seaweed extract, apple extract, and cucumber extract. For example the aqueous solution may contain from about 0.0025% to about 1.5% of aloe vera.

The aqueous solution may also include a fragrance. Generally, the fragrance will contain a blend of aroma compounds and inert carrier compounds that do not contribute to the scent of the fragrance. Aroma compounds usually include compounds described as having top notes, middle notes and/or base notes. Top note compounds are the least resistant to heating and will generally flash off or volatilize quickly upon exposure to elevated temperatures. Middle note compounds, such as aldehydic lifters, are more stable and longer lasting, but are still prone to dissipation over a relatively short period of time or upon repeated exposure to elevated temperatures. Base note compounds are those compounds often characterized as having a “heavy” scent and are the most resistant to dissipation over time, lingering for long periods. One class of base note compounds includes essential oils. Generally, a fragrance may be made of from about 5% to about 50% aroma compounds. Typically, a fragrance may include from about 50% to about 95% inert carrier compounds. Suitable inert carrier compounds can include dipropylene glycol and PEG-40 hydrogenated castor oil.

Desirably, the fragrance includes at least two aroma compounds. More desirably, the fragrance includes at least two aroma compounds each having at least one base note that is thermostable up to at least about 165° F. (about 75° C.). Most desirably, at least one of the aroma compounds is an essential oil. By selecting a fragrance that includes aroma compounds having at least one base note that is thermostable up to about 165° F. (about 75° C.) the fragrance will remain detectable after exposure to heat. Suitable essential oils include ylang ylang, coriander, grapefruit, lavender, white thyme, mandarin orange oil, tuberose, jasmine, lavadin, galbanum, clove leaf, eucalyptus, and geraniol. Other essential oils suitable for use in the present invention include sandalwood, musk, orris root, rose, lily of the valley, bergamot, orchid, ginger, nutmeg, lemongrass, tumeric, rosemary, clove, chamomile, achillea, thulasi and cedar. Additionally, other essential oils known in the art can also be used. Desirably, the fragrance contains from about 0.01% to about 1% of an essential oil.

Optionally, the fragrance may be protected with a fragrance inclusion complex. Examples of fragrance inclusion complexes include molecular entrapment of the base note compounds within a cyclodextrin complex or encapsulation of the fragrance within a gelatin capsule. The use of a fragrance inclusion complex is desirable to reduce the degree of volatilization of the fragrance upon repeated exposure to elevated temperatures. The fragrance inclusion complex also serves to protect the chemical integrity of the fragrance notes until use. The more desirable fragrance inclusion complex is the cyclodextrin inclusion complex since mechanical action is not needed to release the fragrance as is necessary with gelatin encapsulation. Furthermore, cyclodextrin inclusion complexes are more advantageous in aqueous solutions because they are less likely to dissolve in solution over time.

The cyclodextrin inclusion complex is typically formed by dispersing and mixing the fragrance with a cyclodextrin powder. The fragrance is entrapped within the open cyclodextrin structure forming a water-dispersible paste. The resulting water-dispersible paste is then added to the aqueous solution to be incorporated onto the basesheet. One example of a suitable cyclodextrin complex material is a hydroxypropylbetacyclodextrin which is available under the registered trademark KLEPTOSE HP from Roquette America, Inc., having an office 1417 Exchange Street, P.O. Box 6647, Keokuk, Iowa 52632.

### Methods

A method of making and a method of using a package filled with more than one disposable washcloth are described below.

In one embodiment of the present invention a method of making a disposable washcloth includes providing a continuous web of nonwoven basesheet material, incorporating the aqueous solution described above onto the continuous web of nonwoven basesheet, longitudinally folding the web having the aqueous solution incorporating thereon to a desired width, transversely cutting the folded web at select intervals to create a plurality of individual basesheets, stacking a select number of individual basesheets to form a clip of individual basesheets, and placing the clip of individual basesheets into a package. Desirably the continuous web of nonwoven basesheet has a width dimension of at least about 12 inches (about 30.5 cm). More desirably, the continuous web of nonwoven basesheet had a width dimension of at least about 10 inches (about 25.4 cm). Most desirably, the continuous web of nonwoven basesheet has a width dimension of at least about 8 inches (about 20.3 cm).

The aqueous solution may be incorporated onto the nonwoven web in a continuous or intermittent process. Suitably, the aqueous solution may be incorporated onto the continuous web by passing the web through a spray chamber or immersing the web in a dunk tank containing the aqueous solution. Alternatively, the aqueous solution may be incorporated onto the nonwoven web by other means know to those having skill in the art.

The wetted web may be folded into a c-fold configuration, a z-fold configuration, a quarter-fold configuration or other folded configuration known to those skilled in the art. Desirably, the folded web has a width dimension of about 2 inches (about 5 centimeters) to about 6 inches (about 15 centimeters). More desirably, the folded web has a width dimension of about 3 inches (about 7.5 centimeters) to about 5 inches (about 13 centimeters). Most desirably, the folded web has a width dimension of about 4 inches (about 10 centimeters).

Advantageously, the folded web will be transversely cut at select intervals to form individual basesheets having a length dimension of at least about 12 inches (about 30.5 cm). More advantageously, the folded web will be transversely cut at select intervals to form individual basesheets having a length dimension of at least about 10 inches (about 20.5 cm). Most advantageously, the folded web will be transversely cut at select intervals to form individual basesheets having a length dimension of about 8 inches (about 20.3 cm).

The actual number of individual basesheets placed in a clip may vary. The number may vary from one to infinity. For retail sale, a clip will probably contain less than about 250 individual basesheets, desirably, less than about 100 individual basesheets, and more desirably, less than about 25 individual basesheets. It is contemplated that a clip containing from about 5 to about 20 individual basesheets would be very marketable for home use.

The package should be formed from a flexible polymeric sheet material. Desirably, the polymeric sheet material is liquid impermeable and tear-resistant. The polymeric sheet material should be transparent to microwaves. Advantageously, the package is made of materials that demonstrate chemical stability and physical integrity after multiple heatings to a temperature from about 98° F. (37° C.) to about 248° F. (about 120° C.). As used herein the term “physical integrity” is defined to mean that the package material is resistant to leaks, does not become brittle, combust or otherwise degrade. Suitable polymeric sheet materials include a thin sheet of thermoplastic material such as polyethylene, polypropylene, polyvinyl chloride and the like. The polymeric sheet material may also be made of a composite material including two or more layers of thermoplastic material. Suitably the package should be resealable or recloseable in order to maintain the individual basesheets in a moist condition.

In another embodiment, a method of making a disposable washcloth includes the steps of providing a continuous web of nonwoven basesheet material, incorporating the aqueous solution described above onto the nonwoven basesheet web, transversely perforating the continuous web having the aqueous solution incorporated thereon at select intervals to create a plurality of detachable individual basesheets, winding the perforated web into a roll, transversely cutting said perforated continuous web at a single perforation such that a select number of individual basesheets is contained in the roll, and placing the roll of detachable individual basesheets into a package.

The continuous web may be transversely perforated by any means known in the art. Suitably, the perforations should be formed such that the individual basesheets may be readily detached from each other by a user. Advantageously, the perforations should not weaken the integrity of the continuous web thereby causing the individual basesheets to detach from each other during the rolling process.

Advantageously, the continuous web will be perforated at select intervals to provide detachable individual basesheets having a length dimension of at least about 12 inches (about 30.5 cm). More advantageously, the continuous web will be perforated at select intervals to provide detachable individual basesheets having a length dimension of at least about 10 inches (about 20.5 cm). Most advantageously, the continuous web will be perforated at select intervals to provide detachable individual basesheets having a length dimension of about 8 inches (about 20.3 cm).

The actual number of detachable individual basesheets included in the roll may vary. The number may vary from one to infinity. For retail sale, a package will probably contain less than about 250 detachable individual basesheets, desirably, less than about 100 detachable individual basesheets, and more desirably, less than about 25 detachable individual basesheets. It is contemplated that a package containing from about 5 to about 20 detachable individual basesheets would be very marketable for home use.

In a further embodiment, a method of making a disposable washcloth includes the steps of providing a continuous web of nonwoven basesheet material, incorporating the aqueous solution described above onto the continuous web of nonwoven basesheet material, transversely perforating the continuous web at select intervals to create a plurality of detachable individual basesheets, folding the continuous web at the transverse perforations to create a stack containing a select number of detachable individual basesheets, and placing the stack of detachable individual basesheets in a package.

One method of using the present invention includes providing a package containing a plurality of individual basesheets having the aqueous solution described above incorporated thereon. The package containing the individual basesheets is heated to a select temperature above 98° F. (about 37° C.). One or more of the individual basesheets may then be sequentially or simultaneously removed from the package and used to provide a warm, quick drying and less messy bath to a human being, especially an elderly or bed-bound person. Desirably, the package is resealed after the removal of each individual basesheet or plurality of individual basesheet in order to retain the heat within the package for an extended period of time.

The package containing the individual basesheets may be heated to a temperature of from about 98° F. (about 37° C.) to about 165° F. (about 75° C.). Suitably, the package containing the individual basesheets is initially heated to a temperature of from about 115° F. (about 45° C.) to about 160° F. (about 70° C.). More suitably, the package containing the individual basesheets is initially heated to a temperature of from about 130° F. (about 550) to about 150° F. (about 65° C.).

The package may be heated by placing it in a hot water bath set to a select temperature for a period of time sufficient to warm the individual basesheets. Alternatively, the package may be heated in a microwave oven.

Another method of using the present invention includes providing a package containing a plurality of individual basesheets having the aqueous solution described above incorporated thereon. The package containing the individual basesheets is heated in a microwave oven for a select time. One or more of the individual basesheets may then be sequentially or simultaneously removed from the package and used to provide a warm, quick drying and less messy bath to a human being, especially an elderly or bed-bound person. Desirably, the package is resealed after the removal of each individual basesheet or plurality of individual basesheet in order to retain the heat within the package for an extended period of time.

Specifically, the package containing the individual basesheets is heated in a microwave oven for at least about 10 seconds. More specifically, the package containing the individual basesheets is heated in a microwave for not greater than about 120 seconds. Most specifically, the package containing the individual basesheets is heated in a microwave for about 90 seconds.

### EXAMPLE

The following example is presented to provide a more detailed understanding of the invention. The particular materials and parameters are exemplary and are not intended to limit the scope of the invention.

An aqueous solution composed of the following compounds was applied to individual sheets of a needle-punched nonwoven basesheet made of a blend of 50% polyester and 50% viscose lyocell fibers having a basis weight of about 4 ounces per square yard (about 135 grams per square meter). The solution was incorporated onto the basesheet at a level equivalent to about 260% of the basesheet weight.

| Class | Compound | Percent (%) |
|---|---|---|
| | Deionized water | 94.75 |
| Moisturizer | Potassium lactate | 0.2 |
| Humectant | Sodium polyaspartate | 2.0 |
| Alpha hydroxy acid | Lactic acid | 0.1 |
| Skin vitamin | Dexpanthenol | 1.0 |
| Mild anionic surfactant | Disodium cocopolyglucose | 0.3 |
| | sulfosuccinate | |
| Preservative | Diazolidinyl urea | 0.3 |
| Preservative | Phenoxyethanol | 0.5 |
| Anti-inflammatory agent | Zinc lactate | 0.5 |
| Surfactant enhancer | PEG-7 glyceryl cocoate | 0.3 |
| Fragrance | Fragrance | 0.05 |
| | | 100 |

While the invention has been described in conjunction with several specific embodiments, it is to be understood that many alternatives, modifications and variations will be apparent to those skilled in the art in light of the aforegoing description. Accordingly, this invention is intended to embrace all such alternatives, modifications, and variations that fall within the spirit and scope of the appended claims.

I claim:

1. A disposable article comprising:
a. a nonwoven basesheet; and
b. an aqueous solution applied to said nonwoven basesheet, said aqueous solution including a combination of a moisturizer, a humectant, an alpha hydroxy acid compound, a skin vitamin, a mild surfactant and a preservative, said disposable article providing moisturization and revitalization of a user's skin.

2. The disposable article of claim 1 wherein said nonwoven basesheet is moist.

3. The disposable article of claim 1 wherein said nonwoven basesheet is formed from a blend of viscose-lyocell fibers and polyester fibers.

4. The disposable article of claim 1 wherein said moisturizer is potassium lactate.

5. The disposable article of claim 1 wherein said humectant is sodium polyaspartate.

6. The disposable article of claim 1 wherein said mild surfactant is an anionic surfactant or an amphoteric surfactant.

7. The disposable article of claim 1 further comprising an anti-inflammatory agent.

8. The disposable article of claim 1 further comprising an emollient.

9. A disposable article comprising:
a. a nonwoven basesheet; and
b. an aqueous solution applied to said nonwoven basesheet, said aqueous solution including a combination of potassium lactate, sodium polyaspartate, an alpha hydroxy acid compound, a skin vitamin, a mild anionic surfactant, a preservative, and an anti-inflammatory agent, said disposable article providing moisturization and revitalization of a user's skin.

10. The disposable article of claim 9 wherein said alpha hydroxy acid compound is lactic acid.

11. The disposable article of claim 9 wherein said skin vitamin is panthenol.

12. The disposable article of claim 9 wherein said mild anionic surfactant is disodium cocopolyglucose sulfosuccinate.

13. The disposable article of claim 9 wherein said anti-inflammatory agent is zinc lactate.

14. A disposable article comprising:
a. a nonwoven basesheet; and
b. an aqueous solution applied to said nonwoven basesheet, said aqueous solution including a combination of potassium lactate, sodium polyaspartate, lactic acid, panthenol, disodium cocopolyglucose sulfosuccinate, a preservative, zinc lactate, and PEG-7 glyceryl cocoate, said disposable article providing moisturization and revitalization of a user's skin.

15. The disposable article of claim 14 wherein said preservative is diazolidinyl urea, 1,3-di-(hydroxymethyl)-5,5-dimethylhydantoin, 3-iodo-2-propynyl butyl carba mate, methyl paraben, disodium ethylenediamine tetraacetic acid, phenoxyethanol, or a combination thereof

16. The disposable article of claim 14 further comprising a natural botanical.

17. The disposable article of claim 16 where the natural botanical is aloe vera.

18. A method of making a disposable article comprising the steps of:
a. providing a continuous web of nonwoven basesheet;
b. incorporating an aqueous solution onto said continuous web of nonwoven basesheet, said aqueous solution including a combination of a moisturizer, a humectant, an alpha hydroxy acid compound, a skin vitamin, a mild anionic surfactant and a preservative;
c. longitudinally folding said continuous web of nonwoven basesheet having said aqueous solution incorporated thereon;
d. cutting said folded continuous web at select intervals to create a plurality of individual basesheets;
e. stacking a select number of said individual basesheets to provide a clip; and
f. placing said clip within a package.

19. The method of claim 18 wherein said continuous web of nonwoven basesheet is formed from a blend of viscose-lyocell fibers and polyester fibers.

20. The method of claim 18 wherein said continuous web of nonwoven basesheet has a width dimension of at least about 12 inches.

21. The method of claim 18 wherein said aqueous solution is incorporated onto said continuous web by passing said continuous web through a spray chamber.

22. The method of claim 18 wherein said aqueous solution is incorporate onto said continuous web by immersing said continuous web in a dunk tank.

23. The method of claims 18 wherein said longitudinally folded web has a width dimension of from between about 2 inches to about 6 inches.

24. The method of claim 18 wherein said longitudinally folded web has a width dimension of about 4 inches.

25. The method claim 18 wherein said longitudinally folded web is transversely cut at select intervals to form a plurality individual basesheets having a length dimension of at least about 12 inches.

26. The method of claim 18 wherein said clip contains less than about 250 individual basesheets.

27. The method of claim 18 wherein said clip contains less than about 100 individual basesheets.

28. The method of claim 18 wherein said clip contains between about 5 and about 25 individual basesheets.

29. The method of claim 18 wherein said package is transparent to microwaves.

30. A method of making a disposable article comprising the steps of:
a. providing a continuous web of nonwoven basesheet material;
b. incorporating an aqueous solution onto said continuous web of nonwoven basesheet material, said aqueous solution including a combination of a moisturizer, a humectant, an alpha hydroxy acid compound, a skin vitamin, a mild anionic surfactant, and a preservative;
c. perforating said continuous web of nonwoven basesheet material having said aqueous solution incorporated thereon at select intervals to provide a plurality of detachable individual basesheets;
d. winding said perforated continuous web into a roll;
e. transversely cutting said perforated web along a single perforation such that said roll contains a select number of detachable individual basesheets; and
f. placing said roll of detachable individual basesheets into a package.

31. The method of claim 30 wherein said continuous web of nonwoven basesheet material is perforated at select intervals to form a plurality of detachable individual basesheets having a length dimension of at least about 8 inches.

32. The method of claim 30 further comprising the step of longitudinally folding the perforated continuous web.

33. The method of claim 30 where said perforated web is longitudinally folded to form a folded web having a width dimension between about 2 inches and about 6 inches.

34. The method of claim 33 wherein said perforated web is longitudinally folded to form a folded web having a width dimension of about 4 inches.

35. A method of using a disposable article comprising:
a. providing a package containing a plurality of individual basesheets having an aqueous solution incorporated thereon, said aqueous solution including a combination of a moisturizer, a humectant, an alpha hydroxy acid compound, a skin vitamin, a mild anionic surfactant, and a preservative;
b. heating said package to a select temperature above 98° F.; and
c. removing one or more individual basesheets from said package to provide a warm, quick drying bath to a human being.

36. The method of claim 35 wherein said package is heated in a hot water bath.

37. The method of claim 35 wherein said package is heated in microwave oven.

38. The method of claim 35 wherein said package is heated to a temperature between about 98° F. to about 170° F.

39. The method of claim 35 wherein said package is heated to a temperature between about 115° F. and about 160° F.

40. The method of claim 35 wherein said package is heated to a temperature between about 130° F. and about 150° F.

41. The method of claim 35 wherein further comprising resealing said package after removing said individual basesheets.

42. The method of claim 35 wherein a plurality of individual basesheets is removed from the package sequentially.

43. The method of claim 35 wherein a plurality of individual basesheets is removed from said package simultaneously.

44. A method of using a disposable article comprising:
a. providing a package containing a plurality of individual basesheets having an aqueous solution incorporated thereon, said aqueous solution including a moisturizer, a humectant, an alpha hydroxy acid compound, a skim vitamin, a mild anionic surfactant, and a preservative;
b. heating said package in a microwave oven for a select time; and
c. removing one or more individual basesheets from said package to provide a warm, quick drying bath to a human being.

45. The method of claim 44 wherein said package is heated in a microwave oven for at least about 10 seconds.

46. The method of claim 44 wherein said package is heated in a microwave oven for not greater than about 120 seconds.

47. The method of claim 44 wherein said package is heated in a microwave oven for about 90 seconds.

48. The method of claim 44 wherein further comprising resealing said package after removing said individual basesheets.
